(19) United States
(12) Patent Application Publication
(10) Pub. No.: US 2002/0104024 A1
(43) Pub. Date: Aug. 1, 2002

(54) Method for detecting and managing computer viruses in system for sending or receiving electronic mail

(75) Inventors: Taiji Sasage, Yokohama (JP); Tatsuo Yamaoka, Yokohama (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/057,876

(22) Filed: Jan. 29, 2002

(30) Foreign Application Priority Data
Jan. 29, 2001 (JP) 2001-020404

(51) Int. Cl. G06F 11/30; G06F 15/16

(52) U.S. Cl. 713/201; 709/207; 709/224

(57) ABSTRACT

In a method for determining whether or not electronic mail transmitting through a network is infected by a mail virus, it is determined whether or not a first address indicated by the electronic mail transmitting through the network is the same as a second address for mail virus detection, and other electronic mail having the same type of the electronic mail is suppressed from being sent when the electronic mail has the second address for the mail virus detection.

### BACKGROUND OF THE INVENTION

1. Field of the Invention

The present invention generally relates to a method for detecting and managing computer viruses in a system for sending or receiving electronic mail.

2. Description of the Related Art

In a computer environment of a mail system and mail system client, information concerning known computer viruses (for example, a pattern file) is provided, and a computer virus is detected by comparing a file in a computer or data attached to electronic mail (hereinafter, simply called mail) with a content of the pattern file. After that, a mail send/receive log is examined and then a process for detected computer viruses is conducted.

However, conventionally, only computer viruses whose information is included in the pattern file are detected. Therefore, an unknown computer virus is generally detected and managed after damage by the unknown computer virus has already been spread widely and the unknown computer is defined.

In a case in which the computer virus is a computer virus (hereinafter called mail virus) sending the same type thereof as mail, to mail addresses registered in a mail address book, not only a computer of a mail receiver is infected but also other computers for other users addressed in the address book can be infected. In this case, since the mail receiver becomes a mail sender, the mail receiver can be a virus sender. However, conventionally, there is no countermeasure for such the unknown mail virus that would spread the damage and increase the number of users having computers infected from the unknown virus.

### SUMMARY OF THE INVENTION

It is a general object of the present invention to provide a method for detecting and managing computer viruses in a system for sending or receiving electronic mail, in which the above-mentioned problems are eliminated.

A more specific object of the present invention is to provide the method for detecting and managing computer viruses in a system for sending or receiving electronic mail, in which such an unknown mail virus can be detected at an earlier stage, mail considered to be infected with the mail virus can be suppressed from being transmitted, and information of the mail virus and a mail send/receive log of a sender can be reported to an indicated mail address.

According to the present invention, a mail virus detecting system includes an address determining part, a mail suppressing part, and a virus reporting part.

The address determining part determines whether or not a mail address is an address for mail virus detection that is not generally scheduled to send. The virus reporting part sends mail to a person to whom it is required to report mail address detection showing that mail has been sent to the address for mail virus detection. The mail suppressing part suppresses the sending of other mail of the same type as the mail sent to the address for the mail virus detection.

In a usage of the present invention, a mail manager prepares a mail address that is not used by any user. The mail address is registered to an address book of a mail system client as an address for the mail virus detection. And the mail address is not generally sent since there is no user for the mail address. That is, the mail virus is widely spread to many users because the mail virus has a feature of using the address book of the mail system client. However, according to the present invention, in a case in which the mail virus enters the LAN, it is possible to detect the mail virus immediately when the mail virus is sent to the address for the mail virus detection. Accordingly, after that, the mail that may be infected can be automatically suppressed from being sent and it is possible to automatically report information of the mail virus and the mail send/receive log to a predetermined address.

### BRIEF DESCRIPTION OF THE DRAWINGS

Other objects, features, and advantages of the present invention will become more apparent from the following detailed description when read in conjunction with the accompanying drawings, in which:

FIG. 1 is a diagram showing an example of an entire network where a mail virus detecting system is applied to transmit mail, according to an embodiment of the present invention;

FIG. 2 is a diagram showing a detailed operation of a main process of a mail virus detecting system;

FIG. 3 is a diagram showing a detailed example of an address check process;

FIG. 4 is a diagram showing a detailed example of a mail virus report process;

FIG. 5 is a diagram showing the detailed example of the mail virus report process;

FIG. 6 is a diagram showing a configuration of a mail virus address table;

FIG. 7 is a diagram showing a configuration of a mail virus information table;

FIG. 8 is a diagram showing a configuration of a suppressing condition setting table;

FIG. 9 is a diagram showing a configuration of a report level table;

FIG. 10 is a diagram showing a configuration of a mail virus report-to table;

FIG. 11 is a diagram showing a mail header used on a LAN or the Internet;

FIG. 12 is a diagram showing a detailed example of the mail suppressing process; and

FIG. 13 is a diagram showing a hardware configuration of the mail virus detecting system according to the embodiment of the present invention.

### DESCRIPTION OF THE PREFERRED EMBODIMENTS

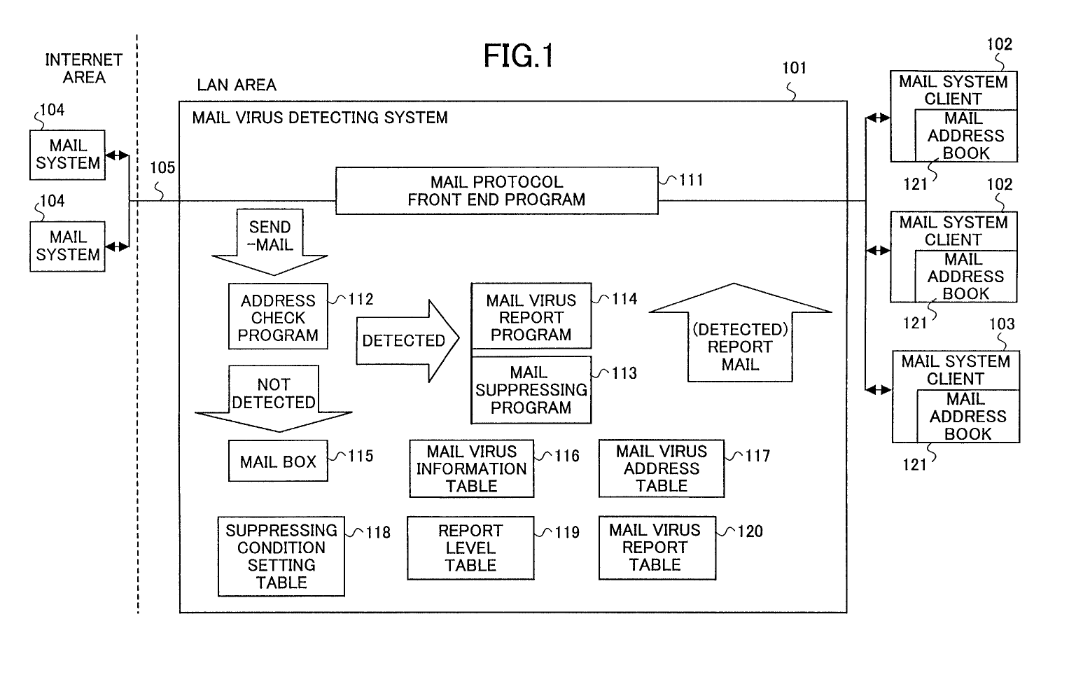

FIG. 1 is a diagram showing an example of an entire network where a mail virus detecting system is applied to transmit mail, according to an embodiment of the present invention.

A mail virus detecting system 101, at least one mail system client 102, a mail system client 103 for a mail manager, and at least one mail system 104 on the Internet are connected to a network 105.

The mail virus detecting system 101 includes a mail protocol front-end program 111, an address check program 112, a mail suppressing program 113, a mail virus report program 114, a mail box 115, a mail virus information table 116, a mail virus address table 117, a suppressing condition setting table 118, a report level table 119, and a mail virus report-to table 120.

Before the mail system client 102 uses the mail system 104, a mail address, which is to be used for mail virus detection but generally is not used, is registered to a mail address book 121. It should be noted that the mail address registered to the mail address book 121 is a value registered in the mail virus address table 117.

In a registration method in this case, a predetermined mail address is manually registered to the mail address book 121 of the mail system client 102. Alternatively, an automatic issuing method can be programmed and installed to automatically issue an address for mail virus detection by requesting a mail address for an inquiry in the mail virus detecting system 101 from the mail system client 102.

After that, a mail sent from the mail system client 102 is received by the mail protocol front-end program 111, and the address check program 112 checks whether or not the mail is sent to the address for the mail virus. Generally, the address for the mail virus is not sent. Thus, it is checked whether or not the mail is infected with the mail virus and sent to the mail virus detecting system 101.

If the mail sent from the mail system client 102 is not infected, that is, a destination of the mail does not correspond to that of the mail address for the mail virus detection, the mail sent from the mail system client 102 is stored in the mail box 115. In a case in which the destination of the mail indicates a different domain, the mail is transmitted to another mail system of the different domain.

If the mail shows a destination toward the address for the mail virus detection, that is, if the mail is infected with the mail virus, the address check program 112 detects the mail infected with the mail virus (hereinafter called infected mail virus), and reports a mail virus infection to the mail suppressing program 113 and the mail virus report program 114.

The mail suppressing program 113 stores a size, a title, a sender, and data and time of the infected mail, and after that, mail having the same condition as the infected mail is suppressed from being sent.

On the other hand, the mail virus report program 114 automatically sends a mail showing the mail virus detection to the mail system client 102, which is a sender of the infected mail, and the mail system client 103 for the mail manager.

The mail system client 102 and the mail system client 103 for the mail manager can recognize that the mail system client 102 and the mail system client 103 themselves and a LAN (Local Area Network) system thereof are infected with the infected mail by receiving the mail reporting the mail virus detection (hereinafter called report mail). Therefore, a countermeasure process for the infected mail can be conducted immediately.

The mail virus detecting system 101 can be realized by computer programs executed by a control of an OS (Operating System) of a computer including a CPU (Central Processing Unit), a memory, an external storage unit, and a like. A program for the mail virus detecting system 101 is stored to a removable recording medium such as a floppy disk or CD-ROM, or is downloaded in the external storage unit via a network and then loaded to the memory to be executed by the CPU.

FIG. 11 is a diagram showing a mail header used on a LAN or the Internet.

The mail header shows “from:” to indicate a sender mail address sending a mail, “to:” to indicate a receiver mail address receiving the mail, “cc:” to indicate a receiver mail address (cc mail addresses) to which a carbon copy of the mail is sent, “reply-to:” to indicate a receiver mail address (reply-to address) to reply the mail received from the sender, and “return-path:” to indicate a receiver mail address (return-path mail address) receiving an error mail.

Accordingly, when the mail virus is detected, it is possible to report the mail virus detection to the sender mail address of the infected mail, the receiver mail address, the reply-to mail address, and a like.

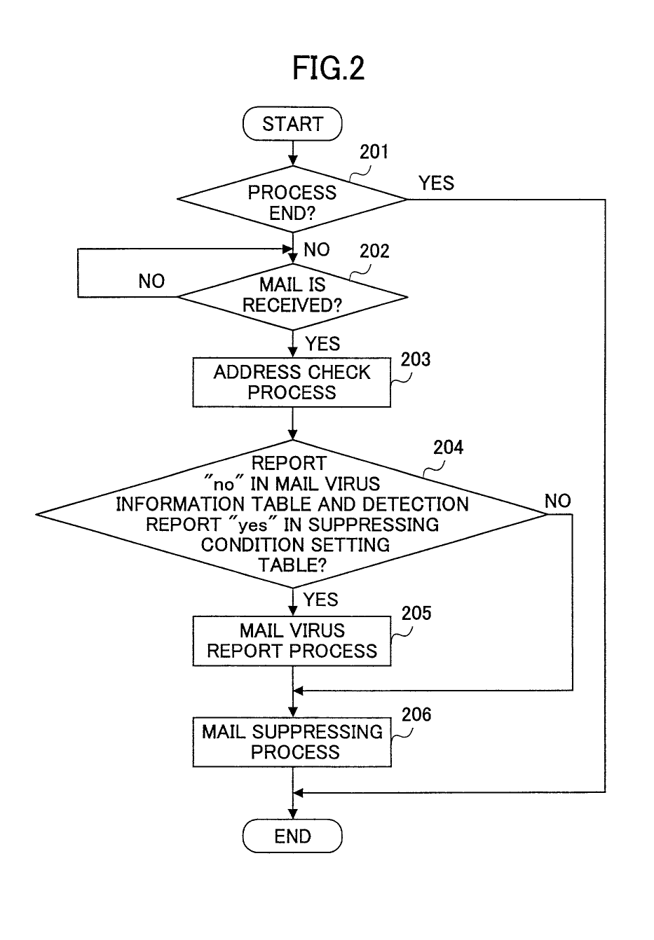

FIGS. 2 through FIGS. 5 are flowcharts for explaining operation steps executed in the mail virus detecting system 101 according to the embodiment of the present invention.

FIG. 7 is a diagram showing a configuration of the mail virus information table 116. The mail virus information table 116 is used to record a summary of the mail virus and includes five items such as “RECEIVED DATE & TIME”, “SENDER”, “SIZE”, “TITLE”, and “REPORT”. “RECEIVED DATE & TIME” shows a date and time when the mail virus detecting system 101 receives the infected mail infected with the mail virus. “SENDER” shows the sender mail address, and “SIZE” shows a data size of the infected mail. “TITLE” shows a title of the infected mail, and “REPORT” shows whether or not the mail virus detection is reported to the sender of the infected mail or a necessary mail address (refer to a mail virus report-to table 120). The mail virus detection has been reported when the “REPORT” shows “DONE”, and the mail virus detection has not been reported yet when “REPORT” shows “NOT YET”.

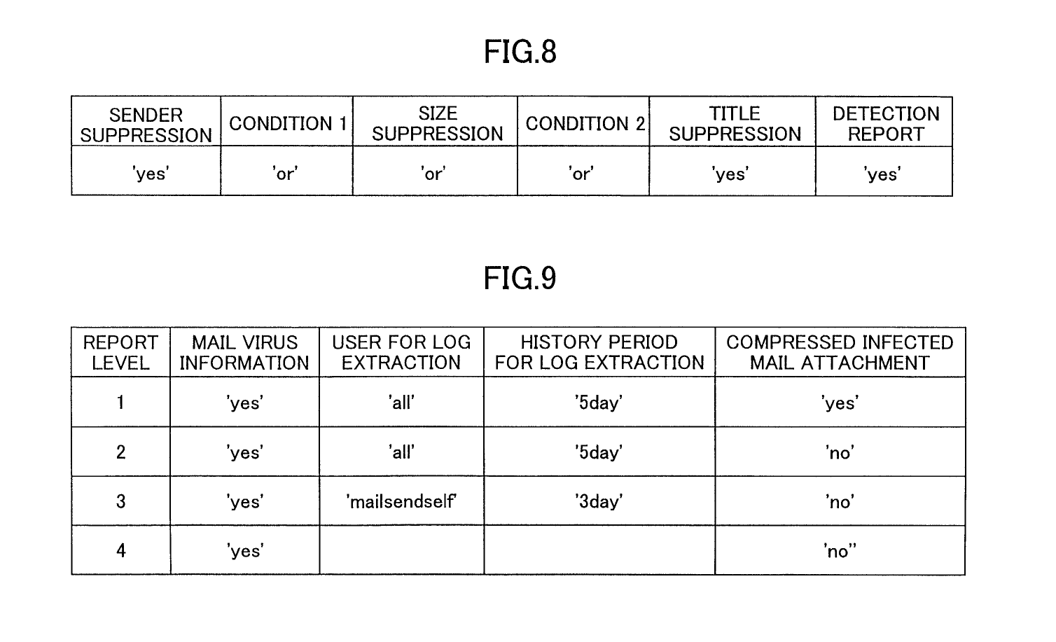

FIG. 8 is a diagram showing a configuration of the suppressing condition setting table 118. The suppressing condition setting table 118 is a table to define a reference in order to determine that the mail sending/receiving through the mail virus detecting system 101 is infected with the mail virus. The suppressing condition setting table 118 includes six items such as “SENDER SUPPRESSION”, “CONDITION 1”, “SIZE SUPPRESSION”, “CONDITION 2”, “TITLE SUPPRESSION”, and “DETECTION REPORT”. “SENDER SUPPRESSION” indicates whether or not the mail from “SENDER” stored in the mail virus information table 116 is suppressed. “SIZE SUPPRESSION” indicates whether or not the mail having the same size defined by “SIZE” of the mail virus information table 116 is suppressed. “TITLE SUPPRESSION” indicates whether or not the mail having the same title defined by “TITLE” of the mail virus information table 116 is suppressed. In an example as shown in FIG. 8, when the mail has at least one of the six items showing “YES” in the mail virus information table 116, it is determined that the mail is infected with the mail virus.

If only “SIZE SUPPRESSION” is set to “yes”, all mail having the same size as a reference size is suppressed from being sent.

“CONDITION 1” and “CONDITION 2” are items to suppress the email in accordance with a combination of items “SENDER SUPPRESSION”, “SIZE SUPPRESSION”, and “TITLE SUPPRESSION” indicated by an AND condition or an OR condition. For example, in order to set “YES” to “SENDER SUPPRESSION” and “TITLE SUPPRESSION”, “CONDITION 1” is set to “AND”. Thus, it is possible to suppress the mail having the same sender mail address and the same size to send out.

Thereby, mail virus recognition is conducted by first determining the mail address for the mail virus detection and by using two tables of the mail virus information table 116 and the suppressing condition setting table 118 where the infected mail infected with the mail virus has been registered. Therefore, it is possible to recognize the mail virus by a combination of the title, the size, and a like.

Detailed operations of a main process of the mail virus detecting system 101 will now described with reference to FIG. 2.

In a step 201, it is determined whether or not the mail virus detecting system 101 receives a process end command. When the mail virus detecting system 101 receives a process end command, the mail virus detecting system 101 terminates the main process.

On the other hand, when the mail virus detecting system 101 does not receive the process end command, the mail virus detecting system 101 advances to a step 202.

In the step 202, it is determined whether or not the mail virus detecting system 101 receives a mail. When the mail virus detecting system 101 receives the mail, the mail virus detecting system 101 advances to a step 203 to execute the address check program 112 for conducting an address check process (details will be described later).

When the mail virus detecting system 101 does not receive the mail, the mail virus detecting system 101 waits until the mail arrives.

After the address check process is conducted, a comparison/determination is conducted in a step 204 to check whether or not there are data in which “REPORT” shows “NOT YET” in the mail virus information table 116 showing that the address for the mail virus detection is detected, and in which “DETECTION REPORT” shows “yes” in the suppressing condition setting table 118.

When a condition checked in the step 204 is satisfied, the mail virus detecting system 101 advances to a step 205 to execute the virus report program 114 for conducting a virus report process (details will be described later).

When the condition checked in the step 204 is not satisfied, the mail virus detecting system 101 advances to a step 206 to execute the mail suppressing program 113 for conducting a mail suppressing process (details will be described later).

After the virus report process is completed in the step 205, the mail virus detecting system 101 advances to the step 206 to conduct the mail suppressing process.

When the mail suppressing process the step 206 is terminated, the main process by the mail virus detecting system 100 is terminated.

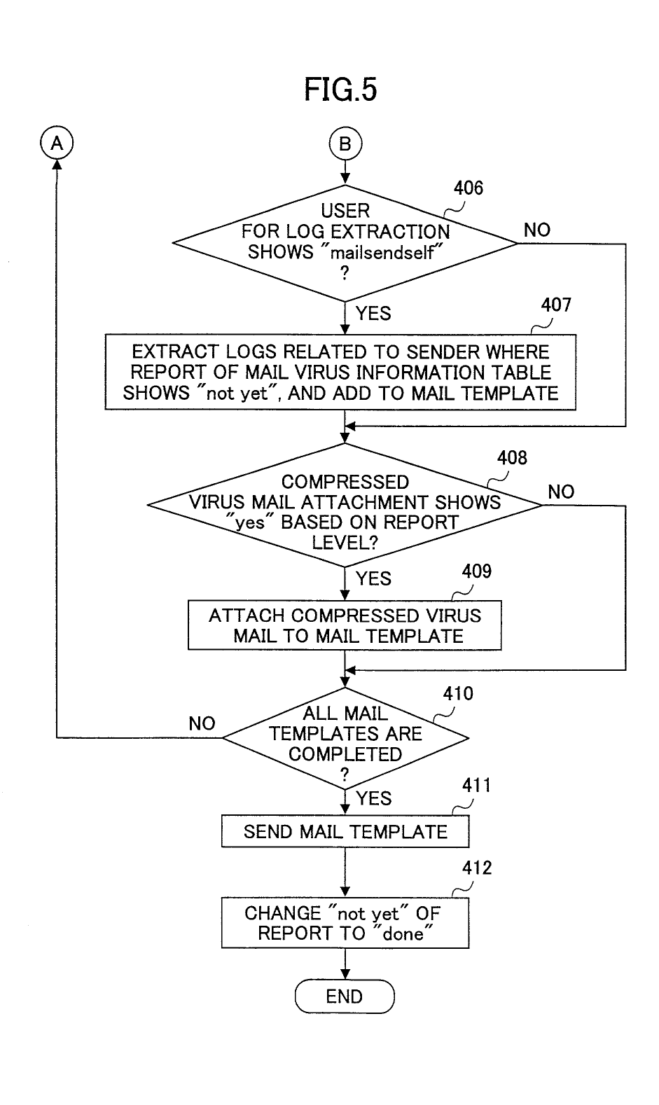

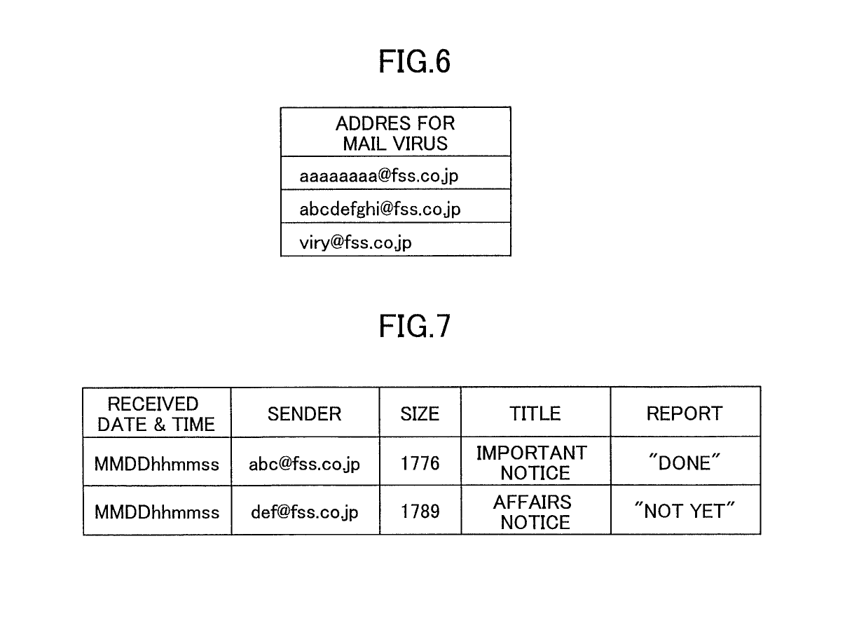

A configuration of the mail virus address table 117 will be described with reference to FIG. 6.

The mail virus address table 117 is used to register an address for mail virus detection provided in each mail system client to the mail virus detecting system, and includes only item of “address for mail virus” which is an address for mail virus detection.

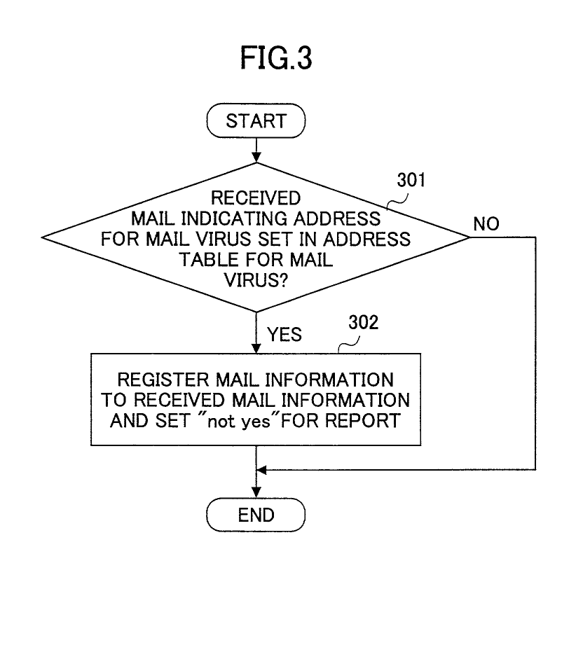

A detailed example of the address check process will be described with reference to FIG. 3.

In a step 301, the comparison/determination is conducted to determine whether or not mail for the “address for the mail virus”, which is the mail address for mail virus detection set in the mail virus address table 117, is received.

When a condition of the step 301 is satisfied, received mail information (“RECEIVED DATA & TIME”, “SENDER”, “SIZE”, and “TITLE”) is registered to the mail virus information table 116 and “REPORT” is set to “NOT YET” in a step 302.

Thus, even if the received mail is the infected mail infected with the mail virus that is not registered to “ADDRESS FOR MAIL VIRUS” of mail virus address table 117, the infected mail can be detected in the step 204 when the infected mail has the same “SENDER”, “SIZE”, OR “TITLE” registered in the mail virus information table 116.

When the condition of the step 301 is not satisfied, the address check process is terminated.

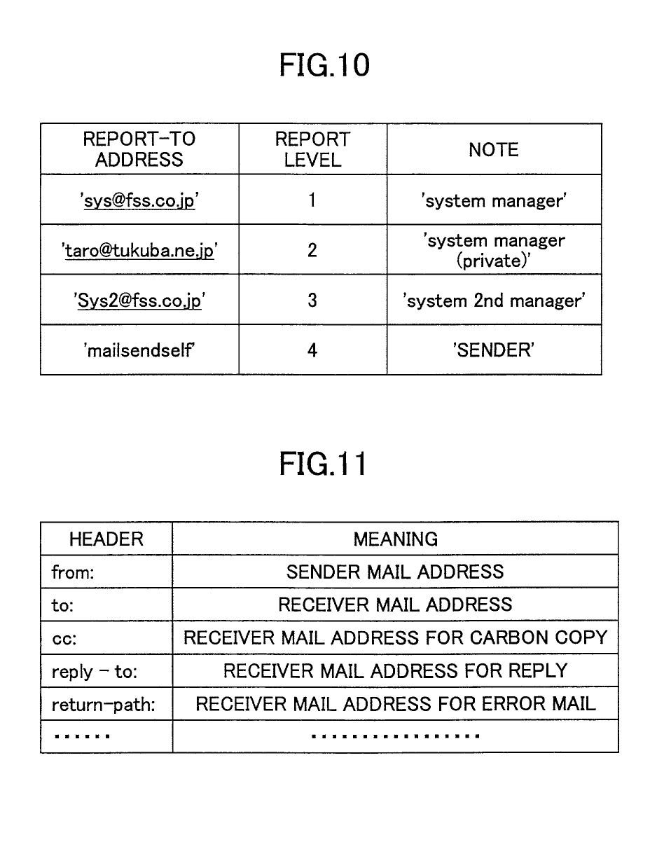

In FIG. 10, a configuration of the mail virus report-to table 120 is shown. The mail virus report-to table 120 is used to register a report-to mail address in order to report when the infected mail with the mail virus is detected, and includes three items of “REPORT-TO ADDRESS”, “REPORT LEVEL”, and “NOTE”.

“REPORT-TO ADDRESS” shows the report-to mail address, “REPORT LEVEL” shows “REPORT-TO” of the report level table 119 (described later). “NOTE” shows detailed report-to information, and also stores information showing whether or not the report-to address is for a system manager or a sender of the infected mail infected with the mail virus.

In FIG. 9, a configuration of the report level table 119 is shown. The report level table 119 is used to register a log related to the infected mail, a period of infection, and a level of attaching a compressed virus mail. The report level table 119 includes five items of “REPORT LEVEL”, “MAIL VIRUS INFORMATION”, “USER FOR LOG EXTRACTION”, “HISTORY PERIOD FOR LOG EXTRACTION”, and “COMPRESSED VIRUS MAIL ATTACHMENT”.

“REPORT LEVEL” shows a combination level of mail virus information (“RECEIVED DATE & TIME”, “SENDER”, “SIZE”, and “TITLE”) and a log concerning sent/received mail, and an extraction period and user to be extracted, and compressed virus mail. “MAIL VIRUS INFORMATION” shows “yes” when information stored in the mail virus information table 116 is sent and shows “no” when the information stored in the mail virus information table 116 is not sent. “USER FOR LOG EXTRACTION” shows a user to extract logs. That is, “USER FOR LOG EXTRACTION” shows “all” for all user, or “mailsendself” for “SENDER” of the mail virus information table 116. “HISTORY PERIOD FOR LOG EXTRACTION” shows the number of days to extract logs. For example, “HISTORY PERIOD FOR LOG EXTRACTION” shows “5day” for five days or “3day” for three days. “COMPRESSED VIRUS MAIL ATTACHMENT” shows whether or not to compress the infected mail infected by the mail virus and to attach a compressed infected mail. For example, “COMPRESSED VIRUS MAIL ATTACHMENT” shows “yes” to attach the compressed infected mail or “no” not to attach the compressed infected mail.

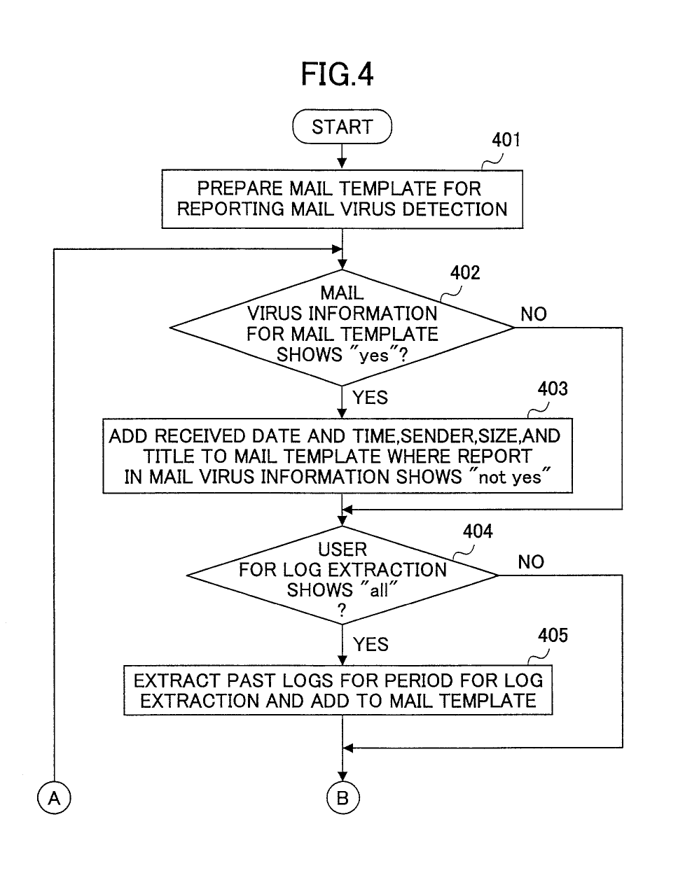

A detailed example of the mail virus report process will be described with reference to FIG. 4 and FIG. 5.

In a step 401, the mail virus report process prepares a mail template for reporting the mail virus detection addressing each “REPORT TO ADDRESS” registered in the mail virus report-to table 120.

For example, “Because mail you sent is recognized as mail infected by a virus, it is not sent to a receiver” is set in mail addressing the sender. “A mail virus is detected. This mail attaches mail virus information (received data and time, sender, size, and title), a mail send/receive log extracting for five days for all users, and a compressed mail that might be infected” is set in mail for a system manager, a system manager (private), and a system 2nd manager.

In a step 402, it is determined whether or not “MAIL VIRUS INFORMATION” of the report level table 119, which corresponds to “REPORT LEVEL” with respect to each address (“REPORT-TO ADDRESS” of the mail virus report-to table 120) addressed in the mail template prepared in the step 401, shows “yes”.

When a condition of the step 402 is satisfied, received data and time, sender, size, and title of the mail is additionally provided in the mail template where the report of the mail virus information shows “NOT YET” for the mail, in a step 403.

On the other hand, when the condition of the step 402 is not satisfied, the mail virus report process skips a step 403.

In a step 404, it is determined whether or not “USER FOR LOG EXTRACTION”, which corresponds to “REPORT LEVEL” of the address of the mail template prepared in the step 401 (“REPORT-TO ADDRESS” of the mail virus report-to table 120), shows “all”,

When a condition of the step 404 is satisfied, from a log file recording mail send/receive information, the mail virus report process extracts past logs for the period for log extraction of “REPORT LEVEL” in the report level table 119 in step 405.

Thus, it is possible to investigate from the log whether how many days the mail has been infected for. A prompt action can be realized to manage the mail virus.

On the other hand, when the condition of the step 404 is not satisfied, the mail virus report process skips the step 405.

Subsequently, in a step 406, it is determined whether or not “USER FOR LOG EXTRACTION” of the report level table 119, which corresponds to “REPORT LEVEL” of the address of the mail template prepared in the step 401 (“REPORT-TO ADDRESS” of the mail virus report-to table 120), shows “mailsendslf”.

When a condition of the step 406 is satisfied, past logs are extracted for the period for the log extraction corresponding to “REPORT LEVEL” in the report level table 119, from the log file recording the mail send/receive in a step 407. In addition, the mail virus report process extracts the logs related to “SENDER” of the mail where “REPORT” of the mail virus information table 116 shows “NOT YET”, and additionally provides extracted logs to the mail template.

Thus, in a case in which “USER FOR LOG EXTRACTION” shows “mailsendself”, the mail virus report process informs “SENDER” of the mail virus information table 116 that the mail “SENDER” sent is infected by the mail virus, and then the prompt action can be taken against the mail virus.

On the other hand, when the condition is not satisfied, the mail virus report process skips the step 407.

In a step 408, it is determined whether or not “COMPRESSED VIRUS MAIL ATTACHEMENT” of the report level table 119, which corresponds to “REPORT LEVEL” of the address of the mail template prepared in the step 401 (“REPORT-TO ADDRESS” of the report level table 119), shows “yes”.

In step 409, when a condition of the step 408 is satisfied, the mail received from the sender is compressed and is attached to the mail template.

On the other hand, when the condition of the step 408 is not satisfied, the mail virus report process skips the step 409.

Subsequently, in step 410, it is determined whether or not all mail templates prepared in the step 401 are completed.

When a condition of the step 410 is satisfied, the mail virus report process sends all mail templates in step 411.

In the step 411, the mail virus report process just sends all mail templates. However, if necessary, a step can be additionally provided in order to automatically report to a mobile phone possessed by the mail system manager.

On the other hand, when the condition of the step 410 is not satisfied, the mail virus report process jumps to the step 402.

In a step 412, the mail virus report process changes “NOT YET” to “DONE” in the “REPORT” of the mail virus information table 116, and then is terminated.

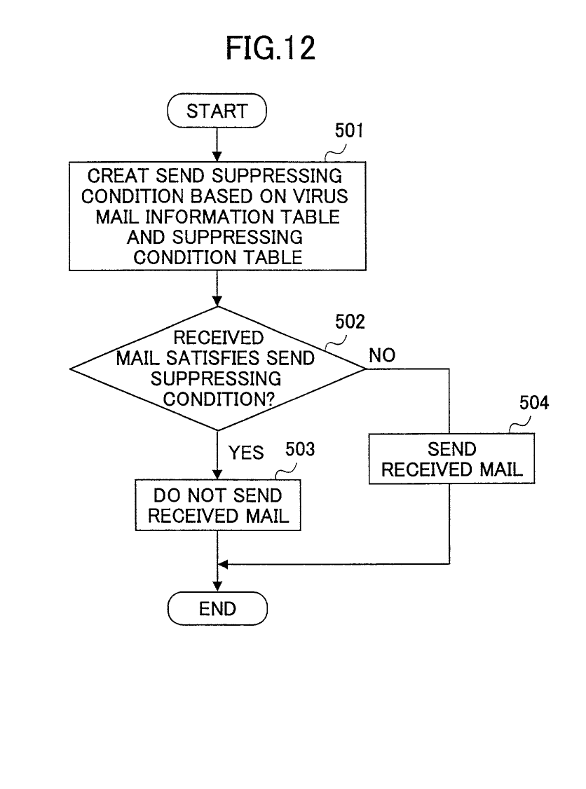

A detailed example of the mail suppressing process will be described with reference to FIG. 12.

In step 501, the mail suppressing process reads “SENDER”, “SIZE”, and “TITLE” from the mail virus information table 116, and reads “SENDER SUPPRESSION”, “CONDITION 1”, “SIZE SUPPRESSION”, “CONDITION 2” and “TITLE SUPPRESSION” from the suppressing condition setting table 118, and creates a send suppressing condition for suppressing the mail to sent the receiver.

Subsequently in a step 502, it is determined whether or not the mail received from the sender satisfies the send suppressing condition.

When the send suppressing condition is satisfied, the mail suppressing process does not send the mail received from the sender, to the receiver indicated in the mail in a step 503. Then, the mail suppressing process is terminated.

On the other hand, when the send suppressing condition is not satisfied, the mail suppressing process sends the mail received from the sender to the receiver indicated in the mail. Then the mail suppressing process is terminated.

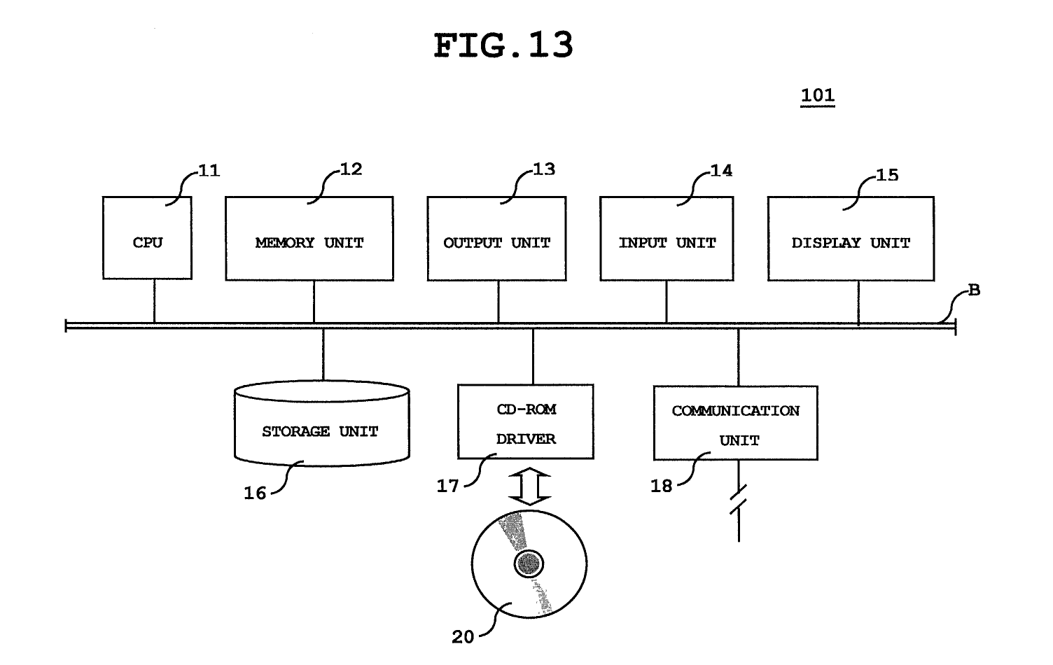

FIG. 13 is a diagram showing a hardware configuration of the mail virus detecting system 101 according to the embodiment of the present invention. In FIG. 13, the mail virus detecting system 101 includes a CPU (Central Processing Unit) 11, a memory unit 12, an output unit 13, an input unit 14, the display unit 15, a storage unit 16, the CD-ROM driver 17, and a communication unit 18, all of which are connected together through a bus B.

The CPU 11 controls mail virus detecting system 101 in accordance with programs stored in the memory unit 12 and also executes processes realizing the processes described above. The memory unit 12 includes a RAM (Random Access Memory) and a ROM (Read Only Memory) and stores the programs executed by the CPU 11, data necessary for the processes, and data obtained by the processes. Also, the memory unit 12 is partially used as a working area for the processes executed by the CPU 11.

The output unit 13 includes a printer or the like and is used to output a process result or indicated information. The input unit 14 includes a mouse, a keyboard, or the like and is used to input information. The display unit 15 displays information for a system manager of the mail virus detecting system 101.

The storage unit 16 includes a hard disk and stores tables including the mail box 115, mail virus information table, the mail virus address table 117, the suppressing condition setting table 118, the report level table 119, and the mail virus report table 120 and programs including the mail protocol front-end program 111, the address check program 112, the mail suppressing program 113, and the mail virus report program 114. The communication unit 18 controls data transmissions for sending or receiving mail.

The programs are installed in the mail virus detecting system 101 by loading the CD-ROM 20 in the CD-ROM driver 17. That is, when the CD-ROM 20 storing the programs is inserted in the CD-ROM driver 17, the CD-ROM driver 17 reads the program from the CD-ROM 20 and the programs read from the CD-ROM 20 are installed in the storage unit 16 via the bus B. When the process is executed, the CPU 11 executes the process in accordance with the program installed in the storage unit 16.

As described above, by applying the present invention to a regular mail system, in a case in which the mail virus enters the LAN, the mail virus can be detected immediately when the mail virus is sent to the address for the mail virus detection.

Also, after that, it is possible to automatically suppress the sending of the mail that may be infected by the mail virus. Moreover, it is possible to report necessary information such as the mail virus information, relative mail send/receive log, and the mail virus itself to a plurality of addresses, depending on a case of the mail virus.

Furthermore, even if the mail is infected by unknown mail virus, it is possible to detect the mail virus at an earlier stage, automatically suppress a spread of the mail virus, investigate an influenced range, and study the mail virus easily.

The present invention is not limited to the specifically disclosed embodiments, variations and modifications, and other variations and modifications may be made without departing from the scope of the present invention.

The present application is based on Japanese Priority Application No.2001-020404 filed on Jan. 29, 2001, the entire contents of which are hereby incorporated by reference.

What is claimed is:

1. A method for determining whether or not electronic mail transmitting through a network is infected by a mail virus, said method comprising the steps of:
(a) determining whether or not a first address indicated by the electronic mail transmitting through the network is a same as a second address for mail virus detection, and
(b) suppressing sending other electronic mail being a same type of the electronic mail when said step (a) determines that the electronic mail indicates the second address for the mail virus detection.

2. The method as claimed in claim 1, further comprising the step of (c) reporting the mail virus detection based on the electronic mail detected in said step (a) to at least one predetermined report-to address.

3. The method as claimed in claim 1, further comprising the steps of:
(d) compressing the electronic mail detected in said step (a); and
(e) attaching the electronic mail compressed in said step (d) to report electronic mail for reporting the mail virus detection,
wherein said step (c) reports the mail virus detection by sending report electronic mail attaching the electronic mail compressed in said step (d).

4. A computer-readable recording medium recorded with program code for causing a computer to determine whether or not electronic mail transmitting through a network is infected by a mail virus, said computer-readable recording medium comprising the codes for:
(a) determining whether or not a first address indicated by the electronic mail transmitting through the network is a same as a second address for mail virus detection, and
(b) suppressing sending other electronic mail being a same type of the electronic mail when said step (a) determines that the electronic mail indicates the second address for the mail virus detection.

5. The computer-readable recording medium as claimed in claim 4, further comprising the code for (c) reporting the mail virus detection based on the electronic mail detected in said code (a) to at least one predetermined report-to address.

6. The computer-readable recording medium as claimed in claim 5, further comprising the code for:
(d) compressing the electronic mail detected in said code (a); and
(e) attaching the electronic mail compressed in said code (d) to report electronic mail for reporting the mail virus detection,
wherein said code (c) reports the mail virus detection by sending report electronic mail attaching the electronic mail compressed in said code (d).
